(19) United States
(12) Patent Application Publication
(10) Pub. No.: US 2006/0053238 A1
(43) Pub. Date: Mar. 9, 2006

(54) DATA EXCHANGEABLE USB DEVICE AND METHOD THEREWITH

(76) Inventors: Ching-Fu Hung, Hsinchu City (TW); Kung-Wang Lee, Hsinchu County (TW); Shih-Chou Juan, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,171

(22) Filed: Nov. 14, 2005

Related U.S. Application Data
(63) Continuation-in-part of application No. 10/605,236, filed on Sep. 17, 2003.

(51) Int. Cl. G06F 13/12; G06F 13/38

(52) U.S. Cl. 710/62

(57) ABSTRACT

The embodiment of the present invention provides an USB device that can be directly connected to another USB device to allow data exchange to take place without involving a use of a computer. Further, the embodiment of the invention also exploits a MP3 codec to allow voice data to be played or recorded via the USB device of the embodiment of the invention.

### CROSS-REFERENCE TO RELATED APPLICATION

This application is a continuation-in-part application of U.S. patent application, filed on Sep. 17, 2003, Ser. No. 10/605,236, which claims the priority benefit of Taiwan application serial no. 92118562, filed Jul. 8, 2003. All disclosures are incorporated herewith by reference.

### BACKGROUND OF TEH INVENTION

1. Field of the Invention

The present invention generally pertains to an universal serial bus (USB) device and a method of data exchanging between two USB devices, and more particularly to an USB device that accesses another USB device without going through a host computer.

2. Description of the Related Art

A portable electronic device is generally equipped with a small memory device such as a flash memory card. For instance, a digital camera (DC) or a personal digital assistant (PDA) commonly uses a flash memory card to store application data. For a small size and a big storage capacity, the flash memory card is used popularly nowadays. It is noted that an electronic device or a computer equipped with a built-in card connector can directly access a flash memory card via the built-in card connector, and if an electronic device or a computer not equipped with a built-in card connector, an external flash memory card reader is required for the electronic device or the computer to access a flash memory card. Further, in a current market, a portable data storage device that integrates a flash memory card and a flash memory card reader together into one is usually named traveling disc. Currently, a size of a traveling disc is small enough to put in a packet and not get noticed, and a storage capacity of a traveling disc is at a range of tens of mega bytes to hundreds of mega bytes. For a feature of small size, big storage capacity, and reusability, a traveling disc is getting popular to become a commonly used portable storage device and has a tendency to replace a floppy disc or a rewritable CD-ROM (compact disc—read only memory).

Upon an exploiting of a current IC technology, a newly developed traveling disc equips with a bigger storage capacity than before and uses a most popular universal serial bus (USB) as its input/output (I/O) interface, the traveling disc becomes one of the best selling computer peripheral devices in the market. However, the traveling disc is a passive device; it must depend on a host computer to store or retrieve data. Without a host computer, a traveling disc will not be able to copy or store data to another traveling disc. Further, a USB port electronic device such as a digital camera must use a computer to transfer image data to a traveling disc using a USB interface. A traveling disc can not connect to an electronic device directly to retrieve or store data.

### SUMMARY OF THE INVENTION

Accordingly, one object of the present invention is to provide an USB data storage device that directly accesses another USB device to retrieve or store data without being through a host computer.

Another object of the present invention is to provide an USB data storage device that is equipped with a MP3 decoder/encoder (codec) to play MP3 music and to transfer an analog voice data to a digital voice data to be stored in its storage.

Yet another object of the present invention is to provide an USB data exchange device that directly accesses another USB device to retrieve or store data without involving a host computer. The USB data exchange device comprises an USB interface module and a function module.

According to one aspect of the present invention, the USB interface module mentioned above comprises an USB host core circuit and an USB device core circuit. The USB host core circuit is activated as an interface to an USB device if the USB device is at device mode. On the other hand, the USB device core circuit of the USB interface module is activated as an interface to an USB device if the USB device is at host mode.

According to another aspect of the present invention, the USB interface module further comprises a first switch, a second switch, and a third switch. A terminal of the first switch is electrically connected to a D+signal line of an USB interface. The other terminal of the first switch is electrically connected to a high voltage level. A terminal of the second switch is electrically connected to the D+signal line, and the other terminal of the first switch is electrically connected to a ground reference. A terminal of the third switch is electrically connected to a D− signal line of the USB interface, and the other terminal of the third switch is electrically connected to the ground reference. As an USB device at device mode connecting to the USB device of the embodiment of the present invention, the first switch is open, and the second and third switches are close. On the other hand, as an USB device at host mode connecting to the USB device of the embodiment of the present invention, the first switch is close, and the second and third switches are open.

According to another aspect of the present invention, the function module comprises a mass storage device, a buffer device, and a control device. The mass storage device is used to store data. When an USB device connecting to the USB device of the embodiment of the present invention is at a device mode, the function module accesses the USB device via the host core circuit to retrieve or store data to the USB device. The buffer device is used to store data temporarily. The control device controls the mass storage device, buffer device, and the USB interface module.

According to yet another aspect of the present invention, the function module further comprises a MP3 codec. The MP3 codec transfers a MP3 music stored in the buffer device to an analog voice data and outputs the analog voice data as the USB device of the embodiment of the present invention is at MP3 play mode.

According to yet another aspect of the present invention, the mass storage device comprises a nonvolatile storage media used to store data and a storage interface used to access data stored in the nonvolatile storage media.

According to yet another aspect of the present invention, the control device comprises a central processing unit (CPU) as a control center of the USB device, a nonvolatile memory to store a driver program of the USB interface module, and a volatile memory used by the CPU to temporarily store CPU data.

According to yet another aspect of the present invention, the USB of the present invention equips a traditional USB device with an USB host function, the USB device of the embodiment of the present invention consists of a function of USB host and a function of USB device. Therefore, a regular USB device can be directly connected to the USB device of the embodiment of the invention, and a data transfer can take place between the two USB devices without involving a use of a computer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. The drawings are as follows.

FIG. 1 depicts a data exchangeable USB device of a preferred embodiment of the present invention in a block diagram.

FIGS. 2A and 2B depict circuit diagrams of a part of an USB interface module of a preferred embodiment of the present invention.

FIG. 3 depicts a MP3 music retrieving and playing flow-chart diagram of a preferred embodiment of the present invention.

### DETAILED DESCRIPTION OF SPECIFIC EMBODIMENTS

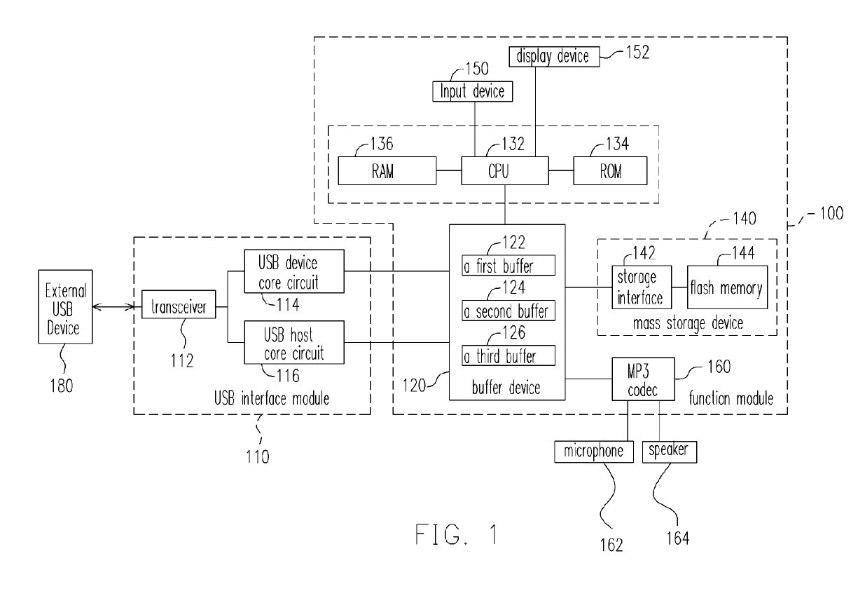

Referring to FIG. 1, a data exchangeable USB device of the preferred embodiment of the present invention is depicted in a block diagram. The data exchangeable USB device of the preferred embodiment of the present invention can be electrically coupled directly to an electronic device with an USB port, such as a portable disc or a digital camera. Hereinafter “external USB device” is denoted for explaining the electronic device with the USB port, which can be connected to the data exchangeable USB device of the embodiment. The data exchangeable USB device comprises an USB interface module 110 and a function module 100.

In the preferred embodiment of the present invention, the USB interface module 110 comprises a transceiver 112, an USB device core circuit 114 and an USB host core circuit 116. The transceiver 112 electrically and mechanically connects to an external USB device 180. The USB device core 114 is activated to interface with the external USB device 180 if the external USB device 180 operates at a host mode. On the other hand, the USB host core circuit 116 is activated as an interface to the external USB device 180 if the external USB device 180 operates at a device mode.

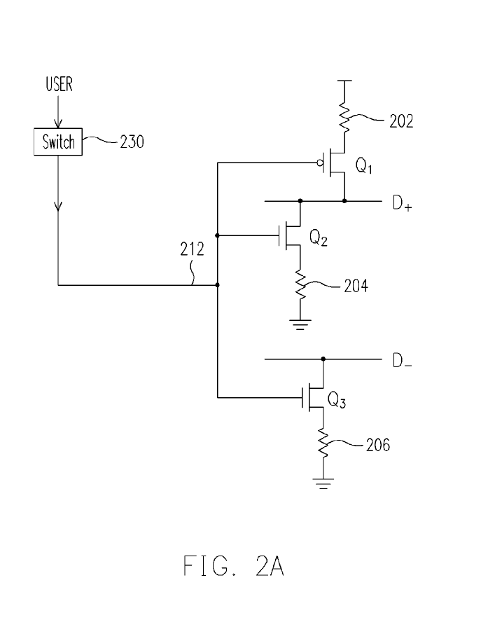

Referring to FIG. 2A, which illustrates a part of circuit diagrams of an USB interface module 110, as illustrated in FIG. 1, of the preferred embodiment of the present invention. The part of circuit diagrams of the USB interface module 110 includes, for example, a first transistor Q1, a second transistor Q2, and a third transistor Q3. Controlling voltage levels of a D+signal and a D− signal, which are defined in the well known USB specification defined in the art field, the USB interface module 110 can operate at a host mode or at a device mode. If the USB interface module 110 operates at the device mode, the USB device core 114 is activated to interface with the external USB device. On the other hand, if the USB interface module 110 operates at the host mode, the USB host core circuit 116 is activated as an interface to the external USB device. A terminal of the first transistor Q1 is electrically connected to a D+signal line of an USB interface, for example, and another terminal of the first transistor Q1 is electrically connected to a high voltage reference via a pull-up resistor 202. A terminal of the second transistor Q2 is electrically connected to the D+signal line of the USB interface, and another terminal of the second transistor Q2 is electrically connected to a ground reference via a first pull-down resistor 204. A terminal of the third transistor Q3 is electrically connected to a D− signal line of the USB interface, and another terminal of the third transistor Q3 is electrically connected to a ground reference via a second pull-down resistor 206.

It is noted that the first transistor Q1 and the second transistor Q2 are of different types, and the second transistor Q2 and the third transistor Q3 are of same type. The three transistors Q1, Q2, Q3 are controlled by a host-mode signal 212 generated by an operation mode control Unit 220. If the host-mode signal is enabled, that is, in a logic high level, the USB interface module circuit 110 operates at the host mode, the USB host core circuit 116 is activated as an interface to the external USB device. When the host-mode signal is in the logic high level, the first transistor Q1 is turned off, and the second and third transistors Q2, Q3 are turned on. On the other hand, if the host-mode signal is disabled, that is, in a logic low level, the USB interface module 110 operates at the device mode, the USB device core 114 is activated to interface with the external USB device. When the host-mode signal is in the logic low level, the first transistor Q1 is turned on, and the second and third transistors Q2, Q3 are turned off.

In accordance with the specification of the USB, the resistance value of the pull-up resistor 202 is 1.5 kΩ while the resistance values of both the first pull-down resistor 204 and the second pull-down resistor 206 are 15 kΩ. According to the preceding descriptions, one of ordinary skill in the art is supposed to realize that the function module 100 of FIG. 1 functions at a host mode and is able to communicate with the external USB device through the USB host core circuit 116 when the host-mode signal is set to be a logic high level (namely enabled). Namely, the function module 100 of the present invention is able to issue a read-instruction or a write-instruction to the external USB device. On the other hand, the function module 100 of the present invention functions at a device mode and is able to communicate with the another USB device that functions at a host mode through the USB device core circuit 114 when the host-mode signal is set to be a logic low level (namely disabled). That is, the another USB device is able to issue a read-instruction or a write-instruction to the function module 100 of the present invention. In other words, whether the USB host core circuit 116 and the USB device core circuit 114 are activated is determined in accordance with the logic level of the host-mode signal.

As stated above, in one embodiment as shown in FIG. 2A, the host-mode signal 212 can be generated according to a status of a switch 2301n the case that the host-mode signal 212 can be determined by an user, when the user has already known the external USB device is to function at a host mode or a device mode, they are able to turn on or off the switch 230 so as to allow the function module 100 of FIG. 1 to function at the device mode or the host mode.

Please refer to FIG. 2B, which illustrates a part of circuit diagrams of an USB interface module 110 of an alternative embodiment. The circuit diagrams of FIG. 2B is similar with the circuit diagrams shown in FIG. 2A except for generation of the host-mode signal 212. In the embodiment, the host-mode signal 212 is generated according to power supplied through a VBUS line specified in the USB standard, which specifies that the host must provide power to the VBUS line for data transfer. In the case that the host-mode signal 212 can be generated by the power supplied through the VBUS line, as shown in FIG. 2B, and, for example, a voltage detection unit 225 is provided for detecting whether a voltage source is provided through the VBUS line from an external USB device 240. If the voltage source is supplied through the VBUS line, the host-mode signal 212 is set to be in the logic low level. The function module 100 of FIG. 1 will function at the device mode. When there is no voltage source supplied through the VBUS line from the external USB device 240, the host-mode signal 212 is set to be in the logic high level. The function module 100 of FIG. 1 will function at the host mode, which is one of ordinary skill in the art is supposed to realize.

Referring to FIG. 1, in the preferred embodiment of the invention, the function module 100 is electrically connected to an USB interface module. The function module 100 comprises a buffer device 120, a control device 130 and a mass storage device 140. The mass storage device is used to store data, and when an USB device is at a device mode and is connected to the USB device of the embodiment of the invention, the function module automatically activates the host core circuit 116 to access the USB device connected to it. The buffer device 120 is electrically connected to the mass storage device 140 and the USB interface module 110, and is used to temporarily store data. The control device 130 is used to control the mass storage device 140, the buffer device 120, and the USB interface module 110. In the preferred embodiment of the invention, the mass storage device 140 comprises a storage interface 142 and a flash memory 144 (a nonvolatile storage media). The flash memory 144 is for storing data, and is electrically connected to the storage interface 142 so that the flash memory 144 can be accessed via the storage interface 142.

In the preferred embodiment of the invention, the control device 130 comprises a CPU 132, a read-only memory (ROM) 134 (a nonvolatile memory), and a random access memory (RAM) 136 (a volatile memory). The CPU 132 is a control center of the USB device. The ROM 134 electrically connected to the CPU 132 is used to store a driver program of the USB interface module 110. The RAM 136 is electrically connected to the CPU 132 to temporarily store CPU 132 data.

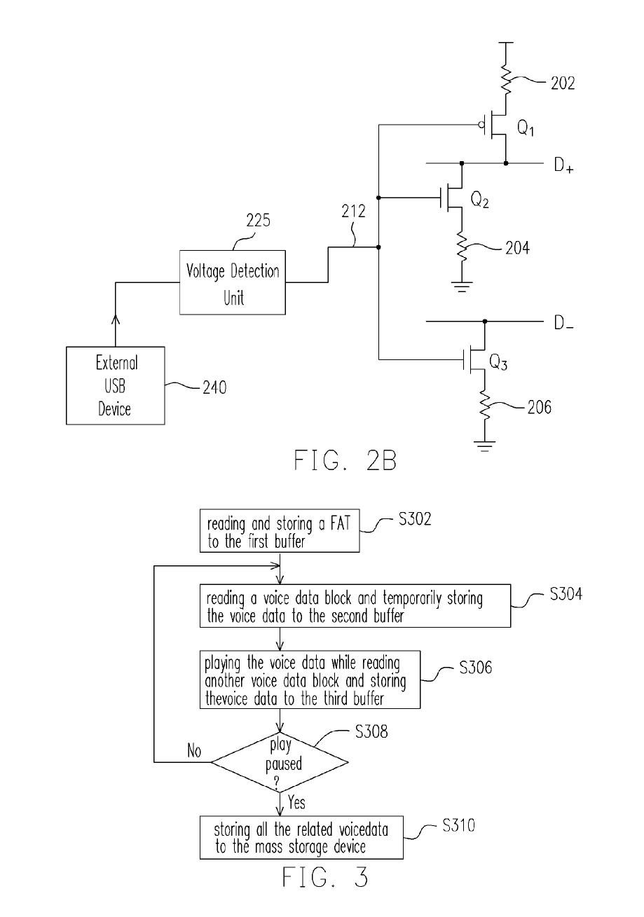

In the preferred embodiment of the invention, the buffer device 120 comprises a first buffer 122, a second buffer 124, and a third buffer 126. The function module 100 further comprises a MP3 codec 160 electrically connected to the buffer device 120 to transfer a MP3 music stored in the buffer device 120 into an analog voice data during a play-state. Referring to FIG. 3, a flow-chart diagram of retrieving and playing MP3 music of the preferred embodiment of the invention is depicted.

Referring to FIG. 1 and FIG. 3, the USB device of the preferred embodiment of the invention (a client USB device) first reads a file allocation table (FAT) from another USB device (host USB device) to the first buffer 122 in step s302. According to the FAT stored in the first buffer 122, voice data stored in a voice data block of the host USB device is read and stored to the second buffer 124 in step s304. Then, while playing a music stored in the second buffer 124, another voice data block of the host USB device is read and stored to the third buffer 126 in step s306. Further, while playing a music stored in the third buffer 126, another voice data block of the host USB device is read and stored to the second buffer 124. By repeating step s304 and step s306, a music stored in the host USB device is played continuously on the client USB device without involving a computer to connect these two USB devices. During a play pause in step s308, all related music data blocks of the host USB device are read and stored to the mass storage device 140 as demonstrated in step s310.

Referring to FIG. 1, when an USB device connected to an USB device according to the preferred embodiment of the present invention is at a host-mode, the USB device of the present invention will automatically configure itself to act at a device-mode to allow the host-mode USB device to access a storage in the device-mode USB device. The host-mode USB device issues a load-instruction or a store-instruction to the device-mode USB device. An instruction from the host-mode USB device first goes to a transceiver 112, then, an USB device core circuit 114, and is temporarily stored in a first buffer 122 of the device-mode USB device. Next, a CPU 132 in the device-mode USB device reads and decodes the instruction from the first buffer 122, and operates accordingly. If the instruction is a read-flash-memory instruction, the CPU 132 provides a corresponding flash memory data and temporarily stores the data to a buffer device 19. Then, the data is transferred to the host-mode USB device via the USB device core circuit 114 and the transceiver 112 of the device-mode USB device. When an USB device is at a device-mode and is connected to an USB device of the embodiment of the invention, the USB device of the embodiment of the invention will automatically configures itself to operate at a host-mode. A memory access or storage access instruction is issued from the host-mode USB device of the embodiment of the invention to the device-mode USB device. A data transfer takes place accordingly as described previously.

In the preferred embodiment of the invention, the function module 100 further comprises a display device 152. The display device 152 is used to display a functional operation status of the USB device. The display device 152 is a liquid crystal display (LCD) or any other kind of display device that can be used to work with the USB device of the embodiment of the present invention.

In the preferred embodiment of the invention, the function module 100 further comprises an input device 150. The input device 150 is a user-friendly interface that provides a mechanism for a user to input an operation instruction. The input device 150 is a keypad, a switch device, or any other kind of user interface that can be used to work with the USB device of the embodiment of the present invention.

In the preferred embodiment of the invention, the USB device also provides an external speaker interface and an external microphone interface so that a voice data stored in the USB device can be played via an external speaker 164, and a voice data can be recorded via an external microphone 162 and the MP3 codec 160 to be stored in the flash memory 144.

As a summary, the data-exchangeable USB device of the embodiment of the present invention can be connected to another USB device directly to allow a data-exchange to take place without involving a use of a computer. Further, via a MP3 codec in the embodiment of the invention, a speaker or a microphone can be directly connected to the data-exchangeable USB device of the embodiment of the present invention to play or to record a voice data accordingly.

People skilled in the art will understand that, to achieve the data exchanging between the data exchangeable USB device of the present invention and the external USB device, the data exchangeable USB device of the present invention does not require to add an additional “ID terminal” to support the OTG (on-to-go) function specified in a supplement standard to the USB 2.0 specification. That is, the data-exchangeable USB device does not include an ID detect circuit for identifying the external USB device operating at a host mode or a device mode. The USB device with the OTG function was disclosed, for example, in U.S. Patent Publication No. 2004/0042138, by Saito et al., which disclosed a data transfer control device with an ID detection circuit for identifying another USB device connected to the data transfer control device operating at a host mode or a device mode. The architecture of identifying the connecting USB device proposed in the present invention is significantly different from that of the conventional USB device.

It will be apparent to those skilled in the art that various modifications and variations can be made to the structure or to the methods of the preferred embodiment of the present invention without departing from the scope or spirit of the invention. In view of the foregoing, it is intended that the present invention cover modifications and variations of this invention provided they fall within the scope of the following claims and their equivalents.

What is claimed is:

1. A data-exchangeable universal serial bus (USB) device, comprises:
a transceiver for electrically and mechanically connecting to an external USB device;
an USB host core circuit, electrically connected to the transceiver and providing a communication with the external USB device when a host-mode signal is set to be a first logic level;
an USB device core circuit, electrically connected to the transceiver and providing a communication with the external USB device when the host-mode signal is set to be a second logic level;
a mass storage device for storing the data;
a buffer device, electrically connected to the mass storage device, the USB host core circuit and the USB device core circuit, for temporarily storing the data; and
a control device, for controlling the mass storage device, the buffer device, the USB host core circuit and the USB device core circuit, wherein the data-exchangeable USB device does not include an ID detect circuit for identifying the external USB device operating at a host mode or a device mode.

2. The data-exchangeable USB device of claim 1, wherein the host-mode signal is determined by an user of the data-exchangeable USB device.

3. The data-exchangeable USB device of claim 1, wherein the host-mode signal is determined by detecting a power source from the external USB device.

4. The data-exchangeable USB device of claim 1, further comprises:
a first switch, electrically connected to a D+signal line of an USB interface at one terminal, and electrically connected to a high voltage level at another terminal;
a second switch, electrically connected to the D+signal line of the USB interface at one terminal, and electrically connected to a ground reference at another terminal; and
a third switch, electrically connected to a D− signal line of the USB interface at one terminal, and electrically connected to the ground reference at another terminal;
wherein the first switch, the second switch and the third switch are controlled by the host-mode signal, the first switch is turned off and the second and third switches are turned on when the host-mode signal is set to be the first logic level, and the first switch is turned on and the second and third switches are turned off when the host-mode signal is set to be the second logic level.

5. The data-exchangeable USB device of claim 1, further comprises:
a first switch, electrically connected to a D+signal line of an USB interface at one terminal, and electrically connected to a high voltage level at another terminal;
a second switch, electrically connected to the D+signal line of the USB interface at one terminal, and electrically connected to a ground reference at another terminal; and
a third switch, electrically connected to a D− signal line of the USB interface at one terminal, and electrically connected to the ground reference at another terminal;
wherein the first switch, the second switch and the third switch are controlled by the host-mode signal, the first switch is turned off and the second and third switches are turned on when the host-mode signal is set to be the first logic level, and the first switch is turned on and the second and third switches are turned off when the host-mode signal is set to be the second logic level.

6. The data-exchangeable USB device of claim 5, wherein the first switch is a first transistor in which a pull-up resistor is used to connect the first transistor to the high voltage level;
the second switch is a second transistor in which a first pull-down resistor is used to connect the second transistor to the ground reference; and
the third switch is a third transistor in which a second pull-down resistor is used to connect the third transistor to the ground reference.

7. The data-exchangeable USB device of claim 1, further comprises:
a MP3 codec, electrically connected to the buffer device, for converting a MP3 data stored in the buffer device to an analog voice data that is then output.

8. The data-exchangeable USB device of claim 1, wherein the buffer device further comprises a first buffer, a second buffer, and a third buffer in which the first buffer temporarily stores a file allocation table from the another USB device, the second buffer and the third buffer temporarily stores a voice data from the another USB device.

9. The data-exchangeable USB device of claim 1, wherein the mass storage device further comprises:
a nonvolatile storage media for storing the data;
a storage interface, electrically connected to the nonvolatile storage media, for accessing the data stored in the nonvolatile storage media.

10. The data-exchangeable USB device of claim 9, wherein the nonvolatile storage media comprising a flash memory.

11. The data-exchangeable USB device of claim 1, wherein the control device comprises:
a central processing unit (CPU), used as a control center of the data-exchangeable USB device;
a nonvolatile memory, electrically connected to the CPU, for storing a driver program of the data-exchangeable USB device; and
a volatile memory, electrically connected to the CPU, for temporarily storing CPU data.

12. The data-exchangeable USB device of claim 1, further comprises a switch device for being manipulated by users to determine a logic level of the host-mode signal.

13. The data-exchangeable USB device of claim 1, wherein a logic level of the host-mode signal is determined in accordance with whether there is provided a voltage source at a connecting port in the another USB.

14. A method of data exchanging between a first universal serial bus (USB) device and a second USB device, wherein the first USB device comprises an USB host core circuit and a device core circuit, the method comprising:
electrically and mechanically connecting the first USB device and the second USB device; and
generating a host-mode signal to configure the first USB device to alternatively electrically provide a communication with the second USB device, wherein when a host-mode signal is set to be a first logic level, the USB host core circuit electrically communicates with the second USB device, and when the host-mode signal is set to be a second logic level, the USB device core circuit electrically communicates with the second USB device, wherein the first logic level is complementary to the second logic level, wherein the first USB device does not perform an ID detecting step for identifying the second USB device operating at a host mode or a device mode.

15. The method of claim 14, wherein the host-mode signal is determined by an user of the first USB device.

16. The method of claim 14, wherein the host-mode signal is determined by detecting a power source from the first USB device.
